(19) United States
(12) Patent Application Publication
(10) Pub. No.: US 2007/0070650 A1
(43) Pub. Date: Mar. 29, 2007

(54) Backlight module and diffusion assembly

(75) Inventors: Shin-Li Chen, Linnei Township (TW); Yu-Yan Fu, Tanzih Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/361,909

(22) Filed: Feb. 24, 2006

(30) Foreign Application Priority Data
Sep. 26, 2005 (TW) 94133328

(51) Int. Cl. F21V 7/04

(52) U.S. Cl. 362/633

(57) ABSTRACT

A diffusion assembly includes a diffuser, an optical film and at least one hanging element. The optical film includes at least one hole inserted by the hanging element. The hanging element is located on the diffuser for engaging with the at least one hole of the optical film. A backlight module comprises a frame, a diffuser and an optical film. The frame comprises at least one hanging element. Both the diffuser and optical film comprise at least one hole for connecting to the hanging element on the frame.

This application claims the benefit of Taiwan Application Serial No. 094133328, filed Sep. 26, 2005, the subject matter of which is incorporated herein by reference.

### BACKGROUND

The invention relates to a backlight module and a diffusion assembly.

Referring to FIG. 1, a conventional backlight module 10 applied to a liquid crystal display comprises a frame 11, a diffuser 12, an optical film 13 and a clipping element 14. The diffuser 12 and the optical film 13 are placed in the frame 11 in sequence. The clipping element 14 and the frame 11 clip the diffuser 12 and the optical film 13 to the frame 11.

The diffuser 12 and the optical film 13 of conventional backlight module 10 are fastened via the clipping element 14 and the frame 11. If the optical film 13 is tightly clipped between the clipping element 14 and the frame 11, the optical film 13 is damaged. If the optical film 13 is loosely clipped between the clipping element 14 and the frame 11, the optical film 13 moves in the backlight module 10 to decrease display quality.

### SUMMARY

The invention provides a backlight module and a diffusion assembly.

A diffusion assembly comprises a diffuser, an optical film and at least one hanging element. The hanging element extends from the diffuser. The optical film comprises at least one hole to connect to the hanging element for hanging the optical film on the diffuser.

A backlight module comprises a frame, a diffuser and an optical film. The frame comprises at least one hanging element. The diffuser and optical film each comprise at least one hole. The holes connect to the hanging element for hanging the diffuser and optical film on the frame.

### BRIEF DESCRIPTION OF THE DRAWINGS

The invention can be more fully understood by reading the subsequent detailed description in conjunction with the examples and references made to the accompanying drawings, wherein:

FIG. 1 is a schematic drawing of a conventional backlight module;

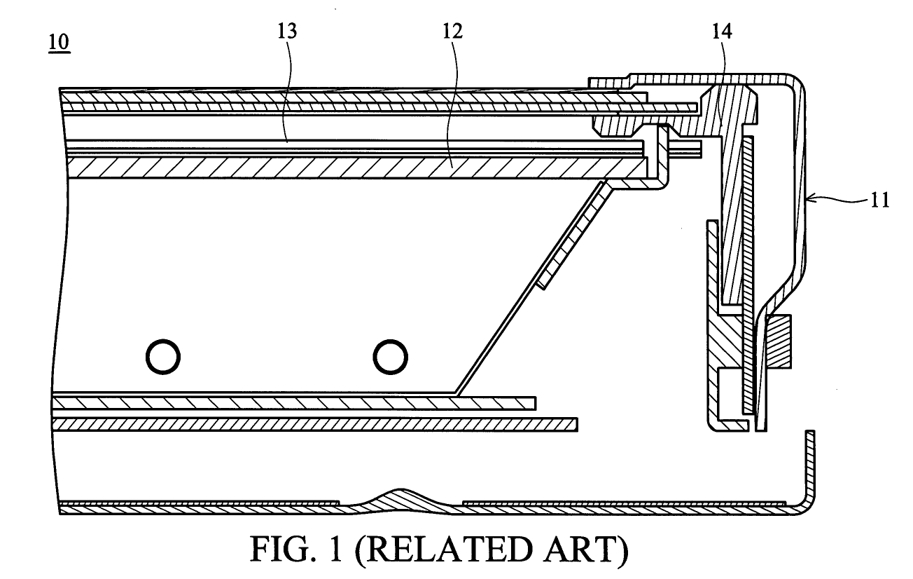

FIG. 2 is an exploded drawing of a diffusion assembly of the invention; and

FIG. 3 is an exploded drawing of a backlight module of the invention.

### DETAILED DESCRIPTION

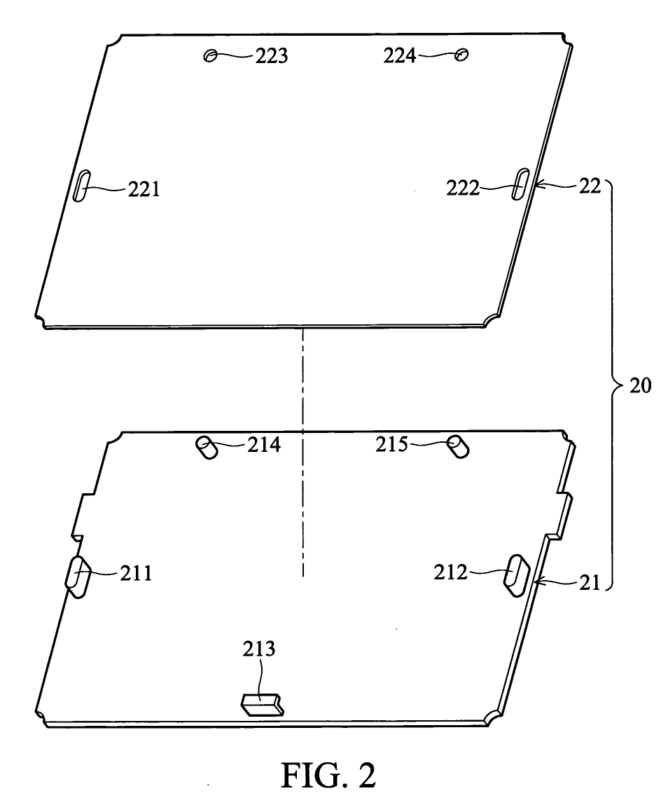

Referring to FIG. 2, diffusion assembly 20 comprises a diffuser 21 and an optical film 22. A plurality of hanging elements 211, 212, 214 and 215 are installed on the diffuser 21. A plurality of holes 221, 222, 223 and 224 corresponding the hanging elements 211, 212, 214 and 215 are installed on the optical film 22. The hanging elements 211, 212, 214 and 215 are protrusions connected to the holes 221, 222, 223 and 224 for fixing the optical film 22 on the diffuser 21. The diffuser 21 further comprises a fixing element 213. The fixing element 213 is substantially L shaped for holding the optical film 22. In the invention, the hanging elements 211, 212, 214 and 215 may be columns or strips. The hanging elements 211, 212, 214 and 215, fixing element 213, and the diffuser 21 are formed as a single, unitary member.

The invention provides the hanging elements 211, 212, 214 and 215 on the diffuser 21 for hanging and fixing the optical film 22 thereon. The diffusion assembly of the invention is applied to a display to avoid movement of the optical film in the frame. Moreover, the diffusion assembly of the invention may prevent damage to the optical film.

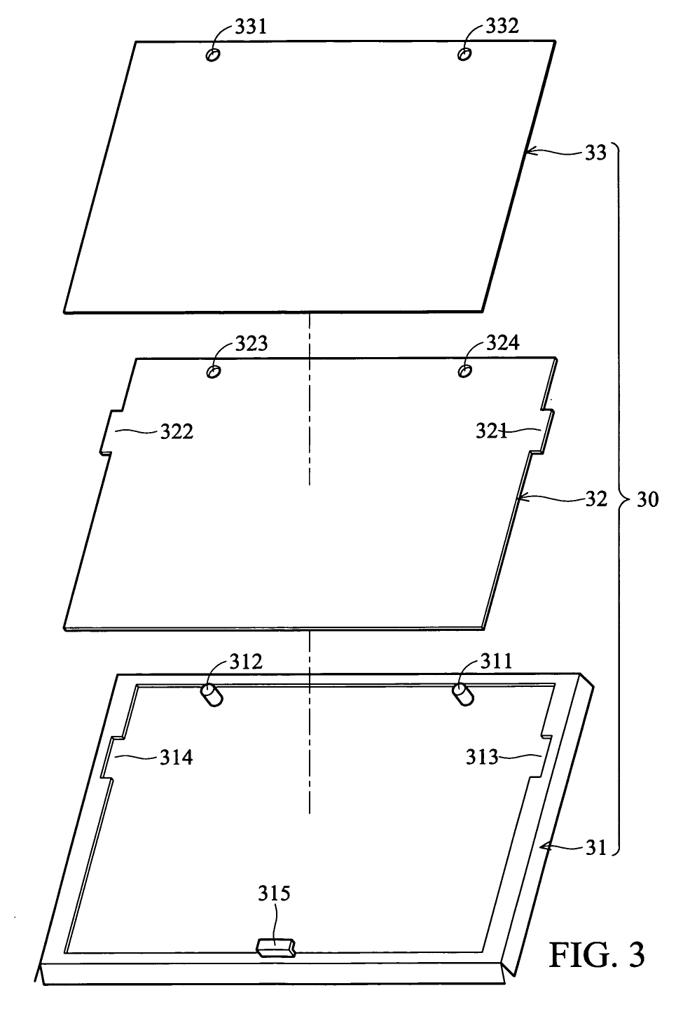

FIG. 3 shows an embodiment of the invention. The hanging elements 311 and 312 are applied to a backlight module 30 for hanging an optical film 33. The backlight module 30 comprises a frame 31, a diffuser 32 and an optical film 33. The diffuser 32 comprises two engaging portions 321 and 322 and holes 323 and 324. The optical film 33 comprises two holes 331 and 332. Two hanging elements 311 and 312 and two depressions 313 and 314 are installed on the frame 31. The hanging elements 311 and 312 pass through the holes 323 and 324 of the diffuser 32 and the holes 331 and 332 of the optical film 33 to provide the diffuser 32 and the optical film 33 to hang in the frame 31. The engaging portions 321 and 322 engage with the depressions 313 and 314 to fix the diffuser 32 in the frame 31 to avoid moving upward, downward, rightward and leftward therein. An L shaped fixing element 315 is located on the frame 31 to hold the diffuser 32 and the optical film 33. The hanging element 311 and 312 may be columns, cones or structures for hanging the diffuser 32 and optical film 33. The hanging element 311 and 312 and the fixing element 315 are formed as a single, unitary member.

The hanging elements 311 and 312 are installed on the frame 31 for hanging the diffuser 32 and optical film 33. The backlight module 30 applied to a display does not require another element for clipping the diffuser and the optical film. Moreover, the backlight module 30 applied to a display can prevent movement of the optical film in the frame 31 during transportation of the display (movement of the optical film in the frame 31 always decreases display quality of a display).

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A diffusion assembly comprising:
a diffuser;
an optical film having at least one hole; and
at least one hanging element located on the diffuser for engaging with the at least one hole of the optical film.

2. The diffusion assembly as claimed in claim 1, wherein the diffuser and hanging element are formed as a single, unitary member.

3. The diffusion assembly as claimed in claim 1, wherein the hanging element is a protrusion.

4. The diffusion assembly as claimed in claim 1, further comprising a fixing element, located on the diffuser, for fixing the optical film.

5. The diffusion assembly as claimed in claim 4, wherein the fixing element is a protrusion.

6. The diffusion assembly as claimed in claim 4, wherein the fixing element is substantially L-shaped.

7. The diffusion assembly as claimed in claim 1, wherein the hanging element comprises a column.

8. The diffusion assembly as claimed in claim 1, wherein the hanging element comprises a strip.

9. A backlight module, comprising:
a frame having at least one hanging element;
a diffusion assembly comprising:
a diffuser;
at least one hole;
an optical film at least one hole; and
at least one hanging element located on the diffuser; and
a light source disposed under the diffusion assembly;
wherein the hole of the diffuser and the hole of the optical film receive the hanging element for connecting the diffuser, the optical film and the frame.

10. The backlight module as claimed in claim 9, wherein the hanging element comprises a column.

11. The backlight module as claimed in claim 9, wherein the frame and hanging element are formed as a single, unitary member.

12. The backlight module as claimed in claim 9, wherein the frame further comprises at least one fixing element for fixing the optical film and the diffuser thereon.
